(19) United States
(12) Patent Application Publication
(10) Pub. No.: US 2016/0326892 A1
(43) Pub. Date: Nov. 10, 2016

(54) CERAMIC COVERED TURBINE COMPONENTS

(71) Applicant: UNITED TECHNOLOGIES CORPORATION, Hartford, CT (US)

(72) Inventors: Grant O. Cook, III, Spring, TX (US); Wendell V. Twelves, Glastonbury, CT (US)

(21) Appl. No.: 15/108,613

(22) PCT Filed: Jan. 5, 2015
(86) PCT No.: PCT/US15/10083

§ 371 Date: Jun. 28, 2016

Related U.S. Application Data
(60) Provisional application No. 61/932,269, filed on Jan. 28, 2014.

(51) Int. Cl. F01D 5/28

(52) U.S. Cl. CPC F01D 5/288; F01D 5/284; F05D 2220/32; F05D 2240/30; F05D 2300/10; F05D 2300/611; F05D 2300/502; F04D 19/00

(57) ABSTRACT

A component for a gas turbine engine comprises an underlying substrate. A plurality of ceramic panels have intermediate thermal expansion joints bonded by a bond layer to the underlying substrate. The thermal expansion joints are formed of a material having a greater coefficient of expansion than a material forming the ceramic panels. The ceramic panels and the thermal expansion joints are positioned to define an outer surface for the component. A gas turbine engine and a component for a gas turbine engine are also disclosed.

### CROSS-REFERENCE TO RELATED APPLICATION

This application claims priority to U.S. Provisional Patent Application No. 61/932,269, filed Jan. 28, 2014.

### BACKGROUND OF THE INVENTION

This application relates to a gas turbine engine component that has ceramic panels separated by a refractory thermal expansion joint.

Gas turbine engines are known and, typically, include a fan delivering air into a compressor and into a bypass duct as propulsion air. The air is compressed in the compressor and delivered into a combustion section where it is mixed with fuel and ignited. Products of this combustion pass downstream over turbine rotors driving them to rotate.

The “hot” part of the engine, namely, the combustor, turbine sections and exhaust nozzle, etc. all must survive very high temperatures. As such, it is known to utilize temperature-resistant materials. One such class of temperature-resistant material is ceramic materials. Ceramic materials have been utilized in liners, as an example, in the combustor and the exhaust nozzle.

Within the turbine section, however, there are a plurality of rotating blades and intermediate vanes all of which include airfoils. These components must also survive very high temperatures. Historically, it has been proposed to cool them by providing air to the components. However, even with extreme steps to provide cooling air, the limits of operation for such components are being approached.

Ceramics are challenging to bond to underlying metal structures and are also quite brittle. Furthermore, the dissimilar coefficients of thermal expansion between metals and ceramics tend to cause cracking and potentially failure of the ceramic or bond interface due to thermal cycling or shock. As such, ceramic materials have not been utilized for components such as airfoils on blades or vanes as described above.

### SUMMARY OF THE INVENTION

In a featured embodiment, a component for a gas turbine engine comprises an underlying substrate. A plurality of ceramic panels have intermediate thermal expansion joints bonded by a bond layer to the underlying substrate. The thermal expansion joints are formed of a material having a greater coefficient of expansion than a material forming the ceramic panels. The ceramic panels and the thermal expansion joints are positioned to define an outer surface for the component.

In another embodiment according to the previous embodiment, the joint is a refractory thermal expansion joint formed of a metallic-based material or a ceramic-based material.

In another embodiment according to any of the previous embodiments, the underlying substrate is a metallic substrate.

In another embodiment according to any of the previous embodiments, the component includes an airfoil and the ceramic panels are mounted on the airfoil.

In another embodiment according to any of the previous embodiments, a cross-section of the joints between adjacent panels is generally rectangular.

In another embodiment according to any of the previous embodiments, a cross-section of the joint between the panels tapers in a direction toward the bond layer such that the joint traps the panels.

In another embodiment according to any of the previous embodiments, a cross-section of the joint between the panels tapers in a direction away from the bond layer such that an outer surface of the thermal expansion joint is minimized compared to an inner size of the cross-section of the thermal expansion joint.

In another embodiment according to any of the previous embodiments, a cross-section of the joint between the components includes smaller end portions and an enlarged central portion.

In another embodiment according to any of the previous embodiments, the panels have hollow backs with legs which are bonded to the substrate.

In another embodiment according to any of the previous embodiments, the panels have a surface area of less than or equal to about 2.0 in² (12.9 cm²).

In another embodiment according to any of the previous embodiments, the panels have the surface area of greater than or equal to about 0.025 in² (0.16 cm²) and less than or equal to about 0.25 in² (1.6 cm²).

In another embodiment according to any of the previous embodiments, the bond layer is a transient liquid phase or partial transient liquid phase bond.

In another featured embodiment, a component for a gas turbine engine comprises an underlying substrate. A plurality of ceramic panels have intermediate thermal expansion joints bonded by a bond layer to the underlying substrate. The thermal expansion joints are formed of a material having a greater coefficient of expansion than a material forming the ceramic panels. The ceramic panels and the thermal expansion joints are positioned to define an outer surface for the component. The joints are a refractory thermal expansion joint formed of a metallic-based material or a ceramic-based material. The underlying substrate is a metallic substrate. The bond layer is a transient liquid phase or partial transient liquid phase bond. The component include an airfoil. The ceramic panels are mounted on the airfoil. The panels have a surface area of less than or equal to about 2.0 in² (12.9 cm²).

In another featured embodiment, a gas turbine engine comprises a compressor, and a turbine section, with a component in the turbine section. The component includes an underlying substrate. A plurality of ceramic panels have intermediate thermal expansion joints bonded to the underlying substrate by a bond layer. The thermal expansion joints are formed of a material having a greater coefficient of expansion than a material forming the ceramic panels. The ceramic panels and the thermal expansion joints are positioned to define an outer surface for the component.

In another embodiment according to the previous embodiment, the joint is a refractory thermal expansion joint formed of a metallic-based material or a ceramic-based material.

In another embodiment according to any of the previous embodiments, the underlying substrate is a metallic substrate.

In another embodiment according to any of the previous embodiments, the component includes an airfoil and the ceramic panels are mounted on the airfoil.

In another embodiment according to any of the previous embodiments, the bond layer is a transient liquid phase or partial transient liquid phase bond.

In another embodiment according to any of the previous embodiments, the panels have a surface area of less than or equal to about 2.0 in² (12.9 cm²).

In another embodiment according to any of the previous embodiments, the panels have the surface area of greater than or equal to about 0.025 in² (0.16 cm²) and less than or equal to about 0.25 in² (1.6 cm²).

These and other features may be best understood from the following drawings and specification.

### BRIEF DESCRIPTION OF THE DRAWINGS

FIG. 1 schematically shows a gas turbine engine.

FIG. 2 shows an airfoil component for use in the FIG. 1 engine.

FIG. 3 shows a detail of a surface of a component.

FIG. 4A shows a first embodiment joint.

FIG. 4B shows a second embodiment joint.

FIG. 4C shows a third embodiment joint.

FIG. 4D shows a fourth embodiment joint.

### DETAILED DESCRIPTION

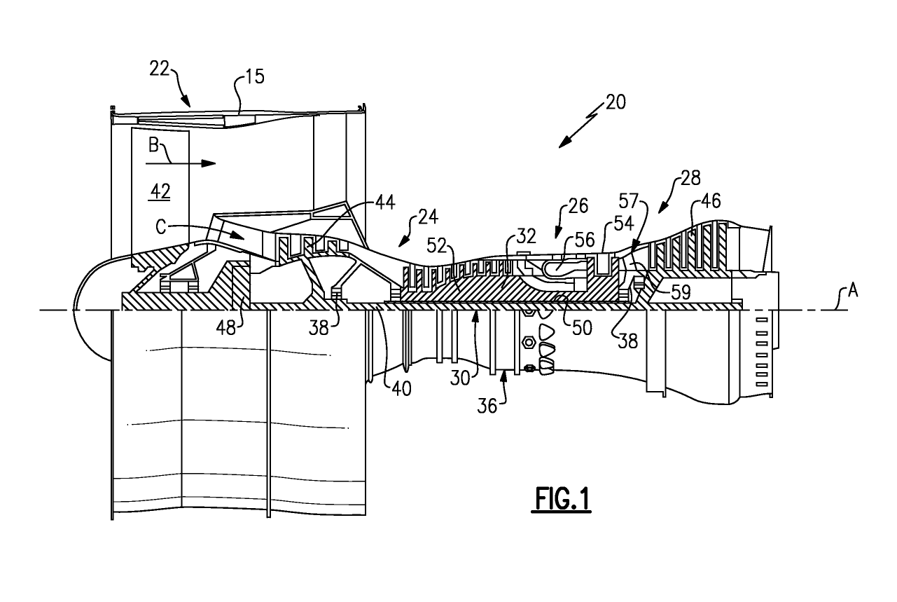

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low-speed spool 30 and a high-speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low-speed spool 30 generally includes an inner shaft 40 that interconnects a fan 42, a first (or low-pressure) compressor 44 and a first (or low-pressure) turbine 46. The inner shaft 40 is connected to the fan 42 through a speed-change mechanism, which in exemplary gas turbine engine 20 is illustrated as a geared architecture 48 to drive the fan 42 at a lower speed than the low-speed spool 30. The high-speed spool 32 includes an outer shaft 50 that interconnects a second (or high-pressure) compressor 52 and a second (or high-pressure) turbine 54. A combustor 56 is arranged in exemplary gas turbine 20 between the high-pressure compressor 52 and the high-pressure turbine 54. A mid-turbine frame 57 of the engine static structure 36 is arranged generally between the high-pressure turbine 54 and the low-pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A, which is collinear with their longitudinal axes.

The core airflow is compressed by the low-pressure compressor 44 then the high-pressure compressor 52, mixed and burned with fuel in the combustor 56, then expanded over the high-pressure turbine 54 and low-pressure turbine 46. The mid-turbine frame 57 includes airfoils 59 which are in the core airflow path C. The turbines 46, 54 rotationally drive the respective low-speed spool 30 and high-speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low-pressure compressor 44, and the low-pressure turbine 46 has a pressure ratio that is greater than about five 5:1. Low-pressure turbine 46 pressure ratio is pressure measured prior to inlet of low-pressure turbine 46 as related to the pressure at the outlet of the low-pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition, typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of pound-mass (lbm) of fuel being burned divided by pound-force (lbf) of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan-tip speed” is the actual fan-tip speed in ft/sec divided by an industry-standard temperature correction of [(Tram ° R)/(518.7° R)]^{0.5}. The “Low corrected fan-tip speed” as disclosed herein according to one non-limiting embodiment is less than about 1150 ft/second.

FIG. 2 shows a component 80 having an airfoil 82. Component 80 is illustrated as a turbine blade and generally has a mount location 85 to be received in a turbine rotor and a platform 83. However, any number of other turbine engine components may benefit from this disclosure. An area 84 is shown expanded within the expanded circle of FIG. 2. As shown, the area 84 includes a plurality of panels or tiles 90 with intermediate joints 92. It should be understood that the entire airfoil 82 may be covered with such tiles and joints. While the tiles 90 are shown as squares, other patterns may be utilized such as hexagonal or irregular configurations.

The panels 90 are formed of ceramic-based materials, such as ceramic matrix composite materials. The joints 92 are refractory thermal expansion joints. The material utilized to form the refractory thermal expansion joints 92 has a coefficient of thermal expansion that is greater than that of the ceramic-based material of the panels 90. Thus, joints 92 expand to hold the panels in compression. Further, the joints 92 have a width sufficient to maintain a required load from this thermal-induced lateral compression to hold the panels 90 tightly and resist pull-off of the panels 90 from an underlying substrate.

The joints 92 are preferably formed of a refractory material that has intermediate properties between those of a metal-based substrate, as disclosed below, and the ceramic-based panels. As an example, metal matrix composites, mechanically alloyed materials or intermetallic materials may be utilized.

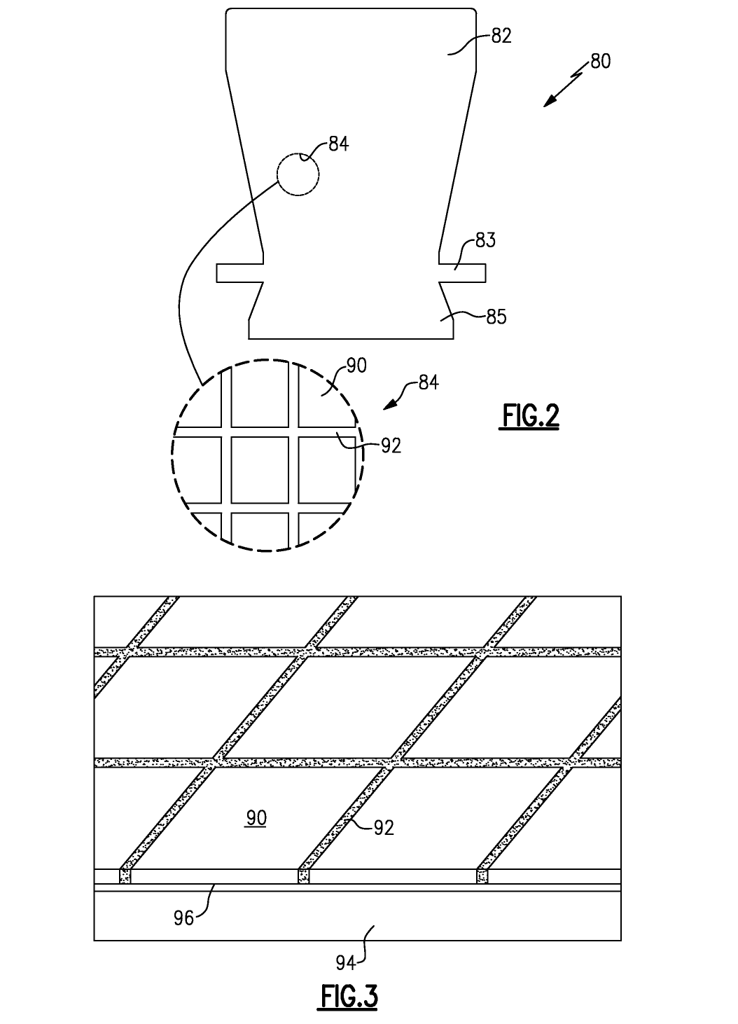

As shown in FIG. 3, the panels 90 and joints 92 are secured by a bond layer 96 to an underlying metal substrate 94. The underlying metal substrate 94 may form a core of the component 80 and, in one example, may be an Inconel™ super alloy. Of course, other metals may be utilized. While the panels 90 and joints 92 may cover the entire outer surface of component 80, they may also cover only selected areas.

The bond layer 96 may be a transient liquid phase bond or a partial transient liquid phase bond.

Transient liquid phase (TLP) bonding and partial transient liquid phase (PTLP) bonding are joining processes that can produce joints with higher melting points than the bonding temperature. TLP bonding is often applied for bonding metallic materials and PTLP bonding is often applied for joining ceramic materials. TLP and PTLP bonding are related and function well to join material systems which cannot be bonded by conventional processes, such as fusion welding. Either bonding process can produce joints with a uniform composition profile after a sufficiently long bonding time, and both are generally tolerant of surface oxides and geometrical defects on bonding surfaces due to the liquid phase that is formed at the bonding interface. TLP bonding has been exploited in a wide range of applications, including in turbine engines. However, it has not been utilized to secure panels 90 and joints 92 as disclosed above.

TLP bonding functions by a change of composition at a bond interface as the interlayer material, which is dissimilar from the parent materials, melts at a lower temperature than the parent materials due to either direct melting or a eutectic reaction with the parent material(s). Thus, a thin layer of liquid forms across an interface at a lower temperature than the melting point of either of the parent ceramic or metallic materials. As the bonding temperature is maintained constant, solidification of the melt occurs isothermally due to diffusion into the parent materials. In PTLP bonding, this isothermal solidification generally occurs by the diffusion of a less-refractory layer of the interlayer into a more-refractory layer of the interlayer that has a melting point above the bonding temperature.

A suitable interlayer is selected by considering its wettability, flow characteristics, stability to prevent deleterious reaction with the base material, and the ability to form a composition having a remelt temperature higher than the bonding temperature. The interlayer can be any of various material formats, such as, but not limited to, a foil, multiple layers of foils, powder, powder compact, braze paste, sputtered layer, or one or more metallic layers applied by electroplating, physical vapor deposition, or another suitable metal deposition process, or combinations thereof.

As examples, copper or nickel may be utilized as the TLP or PTLP interlayer materials. The bond 96 may be on the order of 0.001-0.040 in. in thickness and can be composed of one, two, or three or more layers. The bond 96 can be formed simultaneously with the joint 92 by utilizing a TLP or PTLP interlayer material in said joint. The TLP or PTLP bond may be comprised of large-particle refractory ceramic powder and small-particle diffusant powder or alternating layers of the two. Intermetallic phases may be formed in-situ during the bonding process. Also, as an example, metal matrix composites may be utilized as a TLP bond interlayer material.

The panels 90 may be relatively small and less than 2 in² (12.9 cm²) as an example. In examples, the panels 90 may be greater than or equal to about 0.025 in² (0.16 cm²) and less than or equal to about 0.25 in² (1.6 cm²). The use of the very small panels prevents catastrophic failure should one of the panels fracture or otherwise be damaged before the part can be serviced and the damaged panel(s) be repaired. The smaller sized panel also facilitates the smooth formation of an airfoil shape.

As shown in FIG. 3, one disclosed cross-section of the joint 92 is generally rectangular.

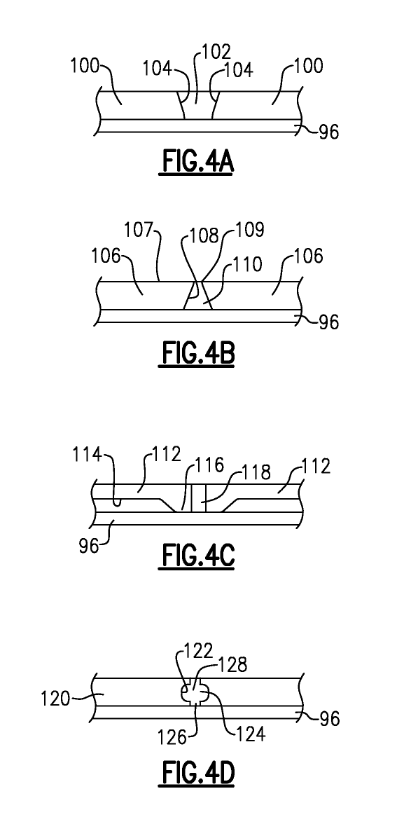

Other example shapes of the joint are illustrated in FIGS. 4A-D.

FIG. 4A shows panels 100 having angled sides 104 which taper in a direction toward the bond layer 96, such that the joint 102 forms an effective mechanical trap holding the panels 100.

FIG. 4B shows panels 106 having tapering edges 108 such that the joint 110 tapers in a direction toward an outer surface 107 of the panel, such that the exposed portion 109 of the joint 110, at the outer surface, is minimized. As can be appreciated, the panels 106 may be able to survive higher temperatures than the joint 110, thus, this minimized exposure may be valuable in some applications.

FIG. 4C shows an embodiment wherein the panels 112 have hollowed backsides 114. The panels also have legs 116 which are bonded by the bond layer 96 to the underlying substrate 94. The joint 118 in this embodiment may be rectangular or may be any other shape.

FIG. 4D shows panels 120 having a joint 124 formed of an enlarged central portion 128 and smaller fingers 122 and 126 at the edges.

Although embodiments of this invention have been disclosed, a worker of ordinary skill in this art would recognize that certain modifications would come within the scope of this invention. For that reason, the following claims should be studied to determine the true scope and content of this invention.

1. A component for a gas turbine engine comprising:
an underlying substrate;
a plurality of ceramic panels having intermediate thermal expansion joints bonded by a bond layer to said underlying substrate, with said thermal expansion joints formed of a material having a greater coefficient of expansion than a material forming said ceramic panels, and said ceramic panels and said thermal expansion joints positioned to define an outer surface for the component.

2. The component for a gas turbine engine as set forth in claim 1, wherein said joint is a refractory thermal expansion joint formed of a metallic-based material or a ceramic-based material.

3. The component for a gas turbine engine as set forth in claim 2, wherein said underlying substrate is a metallic substrate.

4. The component for a gas turbine engine as set forth in claim 1, wherein said component includes an airfoil and said ceramic panels are mounted on said airfoil.

5. The component for a gas turbine engine as set forth in claim 1, wherein a cross-section of said joints between adjacent panels is generally rectangular.

6. The component for a gas turbine engine as set forth in claim 1, wherein a cross-section of said joint between said panels tapers in a direction toward said bond layer such that said joint traps said panels.

7. The component for a gas turbine engine as set forth in claim 1, wherein a cross-section of said joint between said panels tapers in a direction away from said bond layer such that an outer surface of said thermal expansion joint is minimized compared to an inner size of said cross-section of said thermal expansion joint.

8. The component for a gas turbine engine as set forth in claim 1, wherein a cross-section of said joint between said components includes smaller end portions and an enlarged central portion.

9. The component for a gas turbine engine as set forth in claim 1, wherein said panels have hollow backs with legs which are bonded to said substrate.

10. The component for a gas turbine engine as set forth in claim 1, wherein said panels have a surface area of less than or equal to about 2.0 in² (12.9 cm²).

11. The component for a gas turbine engine as set forth in claim 1, wherein said panels have the surface area of greater than or equal to about 0.025 in² (0.16 cm²) and less than or equal to about 0.25 in² (1.6 cm²).

12. The component for a gas turbine engine as set forth in claim 1, wherein said bond layer is a transient liquid phase or partial transient liquid phase bond.

13. A component for a gas turbine engine comprising:
an underlying substrate;
a plurality of ceramic panels having intermediate thermal expansion joints bonded by a bond layer to said underlying substrate, with said thermal expansion joints formed of a material having a greater coefficient of expansion than a material forming said ceramic panels, and said ceramic panels and said thermal expansion joints positioned to define an outer surface for the component;
said joints being a refractory thermal expansion joint formed of a metallic-based material or a ceramic-based material, said underlying substrate being a metallic substrate, said bond layer being a transient liquid phase or partial transient liquid phase bond;
said component including an airfoil and said ceramic panels being mounted on said airfoil; and
said panels having a surface area of less than or equal to about 2.0 in² (12.9 cm²).

14. A gas turbine engine comprising:
a compressor, and a turbine section, with a component in said turbine section;
said component including an underlying substrate;
a plurality of ceramic panels having intermediate thermal expansion joints bonded to said underlying substrate by a bond layer, with said thermal expansion joints formed of a material having a greater coefficient of expansion than a material forming said ceramic panels, and said ceramic panels and said thermal expansion joints positioned to define an outer surface for the component.

15. The gas turbine engine as set forth in claim 14, wherein said joint is a refractory thermal expansion joint formed of a metallic-based material or a ceramic-based material.

16. The gas turbine engine as set forth in claim 14, wherein said underlying substrate is a metallic substrate.

17. The gas turbine engine as set forth in claim 14, wherein said component includes an airfoil and said ceramic panels are mounted on said airfoil.

18. The gas turbine engine as set forth in claim 14 wherein said bond layer is a transient liquid phase or partial transient liquid phase bond.

19. The gas turbine engine as set forth in claim 14, wherein said panels have a surface area of less than or equal to about 2.0 in² (12.9 cm²).

20. The gas turbine engine as set forth in claim 19, wherein said panels have the surface area of greater than or equal to about 0.025 in² (0.16 cm²) and less than or equal to about 0.25 in² (1.6 cm²).
